(19) United States
(12) Patent Application Publication
(10) Pub. No.: US 2024/0182675 A1
(43) Pub. Date: Jun. 6, 2024

(54) FLAME RETARDANT POLYPROPYLENE COMPOSITION

(71) Applicant: BOREALIS AG, Vienna (AT)

(72) Inventors: Wolfgang Stockreiter, Linz (AT); Roberta Pellecchia, Linz (AT); Bettina Friedl, Linz (AT); Paulina Sariomaa, Kulloo (FI); Florian Schütz, Vienna (AT); Francis Reny Costa, Linz (AT); Antonios Gitsas, Linz (AT); Anton Sageder, Linz (AT)

(21) Appl. No.: 18/549,210

(22) PCT Filed: Mar. 11, 2022
(86) PCT No.: PCT/EP2022/056376

§ 371 Date: Sep. 6, 2023

(30) Foreign Application Priority Data
Mar. 11, 2021 (EP) 21162125.5

(51) Int. Cl. C08K 3/32; C08K 3/40; C08K 7/14

(52) U.S. Cl. CPC C08K 3/32; C08K 3/40; C08K 7/14; C08K 2003/321

(57) ABSTRACT

The present invention is directed to a polypropylene composition (C) comprising a propylene polymer (PP), a flame retardant (FR), fibers (F) and optionally an adhesion promoter (AP) as well as an article comprising said polypropylene composition (C).

The present invention is directed to a polypropylene composition (C) comprising a propylene polymer (PP), a flame retardant (FR), fibers (F) and optionally an adhesion promoter (AP) as well as an article comprising said polypropylene composition (C).

Manufacturers of electric motors and power electronic components have been using housings made of steel or die-cast aluminium. However, as many of the components are now actively cooled, plastic solutions are a possibility for lightweight construction. Some of such existing alternatives are mainly based on PC/ABS or polyamide, which are engineering plastics expensive in production and coming with a high CO₂ footprint

Among others, one mandatory requirement for electronic enclosures is to achieve the flammability class UL94 V-0 at a thicknesses of below 1.5 mm. Materials achieving those requirements are most likely metals, halogen based flame retardant-reinforced polymers, polymers with an inherent flame retardant nature, or using non-halogen based flame retardant-reinforced polymers, e.g. PC/ABS flame retardant systems. Due to the high loading of flame-retardant additives in such flame retardant systems, reduction in material performance and problems in conversion occur. Furthermore, an anti-dripping agent is commonly needed to prevent dripping during combustion.

Propylene polymers are also applicable as base polymers for flame retardant systems. Generally speaking, glass fibers are used with polypropylene to achieve certain mechanical properties (e.g. stiffness). The main disadvantage of glass fiber reinforced polypropylene is, however, the dimensional stability in fiber direction and high warpage, especially when high flow polypropylenes are applied as base polymers. Low warpage, however, is essential especially for high precision parts (e.g. cell holder, etc.)

Therefore, it is an object of the present invention to provide a flame retardant reinforced high flow polypropylene composition which fulfils the requirements of UL94 V-0 and shows low warpage while the mechanical properties remain on a high level. Another object of the present invention is to avoid the application of anti-dripping agents, which are often substances with the potential to release toxic components in combustion, like poly-(tetrafluoroethylene) (PTFE).

Accordingly, the present invention is directed to a polypropylene composition (C), comprising
i) 20.0 to 80.0 wt.-% of a propylene polymer (PP) having a melt flow rate MFR₂ (230° ° C., 2.16 kg) determined according to ISO 1133 of at least 45.0 g/10 min,
ii) 10.0 to 40.0 wt.-% of a nitrogen-containing flame retardant (FR),
iii) 10.0 to 40.0 wt.-% of fibers (F), and
iv) 0.0 to 5.0 wt.-% of an adhesion promoter (AP), based on the overall weight of the polypropylene composition (C).

The polypropylene composition (C) does not only provide UL94 V-0 flame retardancy, but at the same time maintains a good mechanical profile. Additionally, UL94 V-0 was reached at a thickness of just 1.5 mm and a low warpage (anisotropy) on top of flame retardancy. Further, the application of anti-dripping additives such as fluoropolymers like PTFE can be avoided.

According to one embodiment of the present invention, the polypropylene composition (C) has a melt flow rate MFR₂ (230° C., 2.16 kg) determined according to ISO 1133 in the range of 6.0 to 40.0 g/10 min.

According to another embodiment of the present invention, the polypropylene composition (C) is free of fluoropolymers.

According to a further embodiment of the present invention, the nitrogen-containing flame retardant (FR) is free of halogens.

According to one embodiment of the present invention, the nitrogen-containing flame retardant (FR) comprises a first nitrogen-containing phosphate (FR1) and a second nitrogen-containing phosphate (FR2).

According to another embodiment of the present invention, the weight ratio between the first nitrogen-containing phosphate (FR1) and the second nitrogen-containing phosphate (FR2) is in the range of 60:40 to 40:60.

It is especially preferred that the first nitrogen-containing phosphate (FR1) is melamine polyphosphate and the second nitrogen-containing phosphate (FR2) is piperazine pyrophosphate.

According to one embodiment of the present invention, the propylene polymer (PP) is a copolymer of propylene and ethylene and/or a C₄ to C₈ α-olefin having a comonomer content in the range of 2.0 to 25.0 mol-%.

According to a further embodiment of the present invention, the propylene polymer (PP) is a heterophasic propylene copolymer (HECO) comprising
i) a matrix (M) being a polymer of propylene, and
ii) an elastomer (E) being a copolymer comprising units derived from propylene and ethylene and/or C4 to C20 a-olefin.

According to another embodiment of the present invention, the heterophasic propylene copolymer (HECO) has a xylene cold soluble fraction (XCS) in the range of 7.0 to 25.0 wt.-%, based on the overall weight of the heterophasic propylene copolymer (HECO).

It is especially preferred that the xylene soluble fraction (XCS) of the heterophasic propylene copolymer (HECO) has
i) a comonomer content above 35.0 mol.-%, and/or
ii) an intrinsic viscosity (IV) measured according to ISO 1628/1 (at 135° C. in decalin) below 3.5 dl/g.

According to one embodiment of the present invention, the fibers (F) are glass fibers (GF), preferably short glass fibers (SGF) having a weight average fiber length determined according to FASEP method as described in “methods” below after injection moulding according to EN ISO 1873-2 in the range of 0.2 to 1.2 mm.

According to another embodiment of the adhesion promoter (AP) is a polar modified polypropylene (PM-PP) being a propylene homo- or copolymer grafted with maleic anhydride having a melt flow rate MFR₂ (230° C., 2.16 kg) determined according to ISO 1133 of at least 20.0 g/10 min.

The present invention is further directed to an article, comprising the polypropylene composition (C) as described above.

It is especially preferred that the article has a shrinkage in flow and cross flow determined as described below in methods below 2.0%.

In the following, the polypropylene composition (C) is described in more detail.

### The Polypropylene Composition (C)

The polypropylene composition (C) according to the present invention comprises a propylene polymer (PP), a nitrogen-containing flame retardant (FR), fibers (F) and optionally an adhesion promoter (AP).

In particular, the polypropylene composition (C) comprises
i) 20.0 to 80.0 wt.-%, preferably 24.0 to 75.0 wt.-%, more preferably 30.0 to 70.0 wt.-%, still more preferably 35.0 to 60.0 wt.-%, like 40.0 to 50.0 wt.-% of the propylene polymer (PP),
ii) 10.0 to 40.0 wt.-%, preferably 15.0 to 35.0 wt.-%, more preferably 18.0 to 38.0 wt.-%, still more preferably 20.0 to 30.0 wt.-%, like 20.0 to 25.0 wt.-% of the nitrogen-containing flame retardant (FR),
iii) 10.0 to 40.0 wt.-%, preferably 12.0 to 38.0 wt.-%, more preferably 18.0 to 35.0 wt.-%, still more preferably 20.0 to 33.0 wt.-%, like 25.0 to 30.0 wt.-% of the fibers (F), and
iv) 0.0 to 5.0 wt.-%, more preferably 0.4 to 3.0 wt.-%, still more preferably 1.0 to 2.0 wt.-%, like 1.2 to 1.8 wt.-% of the adhesion promoter (AP), based on the overall weight of the polypropylene composition (C).

It is preferred that the overall amounts of the propylene polymer (PP), the nitrogen-containing flame retardant (FR), the fibers (F) and optionally the adhesion promoter (AP) together make up at least 90 wt.-% of the polypropylene composition (C).

The polypropylene composition (C) according to the present invention may further comprise additives (AD) such as acid scavengers, antioxidants, colorants, light stabilizers, slip agents, anti-scratch agents, dispersing agents, processing aids, lubricants, pigments, and the like.

Accordingly, it is preferred that the polypropylene composition (C) comprises, more preferably consists of
i) 19.99 to 80.0 wt.-%, preferably 24.0 to 75.0 wt.-%, more preferably 30.0 to 70.0 wt.-%, still more preferably 35.0 to 60.0 wt.-%, like 40.0 to 50.0 wt.-% of the propylene polymer (PP),
ii) 10.0 to 40.0 wt.-%, preferably 15.0 to 35.0 wt.-%, more preferably 18.0 to 38.0 wt.-%, still more preferably 20.0 to 30.0 wt.-%, like 20.0 to 25.0 wt.-% of the nitrogen-containing flame retardant (FR),
iii) 10.0 to 40.0 wt.-%, preferably 12.0 to 38.0 wt.-%, more preferably 18.0 to 35.0 wt.-%, still more preferably 20.0 to 33.0 wt.-%, like 25.0 to 30.0 wt.-% of the fibers (F),
iv) 0.0 to 5.0 wt.-%, more preferably 0.4 to 3.0 wt.-%, still more preferably 1.0 to 2.0 wt.-%, like 1.2 to 1.8 wt.-% of the adhesion promoter (AP), and
v) 0.01 to 5.0 wt.-%, more preferably 0.1 to 3.5 wt.-%, still more preferably 0.2 to 2.0 wt.-%, like 0.3 to 1.0 wt.-% of additives (AD)
   based on the overall weight of the polypropylene composition (C). The additives (AD) are described in more detail below.

It is preferred that the overall amounts of the propylene polymer (PP), the nitrogen-containing flame retardant (FR), the fibers (F), optionally the adhesion promoter (AP) and the additives (AD) together make up at least 90 wt.-% of the polypropylene composition (C), more preferably sum up to 100 wt.-%.

As outlined in more detail below, it is preferred that the fibers (F) are selected from the group consisting of glass fibers, carbon fibers, polymeric fibers, cellulose fibers metal fibers, mineral fibers, ceramic fibers and mixtures thereof. For embodiments of the present invention, wherein the fibers (F) are glass fibers and/or carbon fibers, it is preferred that the polypropylene composition comprises the adhesion promoter (AP).

Therefore, according to a preferred embodiment of the present invention, the polypropylene composition (C) comprises
i) 19.99 to 80.0 wt.-%, preferably 24.0 to 75.0 wt.-%, more preferably 30.0 to 70.0 wt.-%, still more preferably 35.0 to 60.0 wt.-%, like 40.0 to 50.0 wt.-% of the propylene polymer (PP),
ii) 10.0 to 40.0 wt.-%, preferably 15.0 to 35.0 wt.-%, more preferably 18.0 to 38.0 wt.-%, still more preferably 20.0 to 30.0 wt.-%, like 20.0 to 25.0 wt.-% of the nitrogen-containing flame retardant (FR),
iii) 10.0 to 40.0 wt.-%, preferably 12.0 to 38.0 wt.-%, more preferably 18.0 to 35.0 wt.-%, still more preferably 20.0 to 33.0 wt.-%, like 25.0 to 30.0 wt.-% of the fibers (F), and
iv) 0.01 to 5.0 wt.-%, more preferably 0.4 to 3.0 wt.-%, still more preferably 1.0 to 2.0 wt.-%, like 1.2 to 1.8 wt.-% of the adhesion promoter (AP),
   based on the overall weight of the polypropylene composition (C).

It is preferred that the overall amounts of the propylene polymer (PP), the nitrogen-containing flame retardant (FR), the fibers (F) and the adhesion promoter (AP) together make up at least 90 wt.-% of the polypropylene composition (C).

For embodiments wherein the polypropylene composition (C) according to the present invention further comprises additives (AD), it is preferred that the polypropylene composition (C) comprises, more preferably consists of
i) 19.98 to 80.0 wt.-%, preferably 24.0 to 75.0 wt.-%, more preferably 30.0 to 70.0 wt.-%, still more preferably 35.0 to 60.0 wt.-%, like 40.0 to 50.0 wt.-% of the propylene polymer (PP),
ii) 10.0 to 40.0 wt.-%, preferably 15.0 to 35.0 wt.-%, more preferably 18.0 to 38.0 wt.-%, still more preferably 20.0 to 30.0 wt.-%, like 20.0 to 25.0 wt.-% of the nitrogen-containing flame retardant (FR),
iii) 10.0 to 40.0 wt.-%, preferably 12.0 to 38.0 wt.-%, more preferably 18.0 to 35.0 wt.-%, still more preferably 20.0 to 33.0 wt.-%, like 25.0 to 30.0 wt.-% of the fibers (F),
iv) 0.01 to 5.0 wt.-%, more preferably 0.4 to 3.0 wt.-%, still more preferably 1.0 to 2.0 wt.-%, like 1.2 to 1.8 wt.-% of the adhesion promoter (AP), and
v) 0.01 to 5.0 wt.-%, more preferably 0.1 to 3.5 wt.-%, still more preferably 0.2 to 2.0 wt.-%, like 0.3 to 1.0 wt.-% of additives (AD)
   based on the overall weight of the polypropylene composition (C). The additives are described in more detail below.

According to one preferred embodiment, the polypropylene composition (C) comprises, more preferably consists of
i) 19.98 to 80.0 wt.-%, preferably 24.0 to 75.0 wt.-%, more preferably 30.0 to 70.0 wt.-%, still more preferably 35.0 to 60.0 wt.-%, like 40.0 to 50.0 wt.-% of the propylene polymer (PP),
ii) 10.0 to 40.0 wt.-%, preferably 15.0 to 35.0 wt.-%, more preferably 18.0 to 38.0 wt.-%, still more preferably 20.0 to 30.0 wt.-%, like 20.0 to 25.0 wt.-% of the nitrogen-containing flame retardant (FR),
iii) 10.0 to 40.0 wt.-%, preferably 12.0 to 38.0 wt.-%, more preferably 18.0 to 35.0 wt.-%, still more preferably 20.0 to 33.0 wt.-%, like 25.0 to 30.0 wt.-% of the fibers (F),
iv) 0.01 to 5.0 wt.-%, more preferably 0.4 to 3.0 wt.-%, still more preferably 1.0 to 2.0 wt.-%, like 1.2 to 1.8 wt.-% of the adhesion promoter (AP), and
v) 0.01 to 5.0 wt.-%, more preferably 0.1 to 3.5 wt.-%, still more preferably 0.2 to 2.0 wt.-%, like 0.3 to 1.0 wt.-% of additives (AD)
   based on the overall weight of the polypropylene composition (C), and wherein components i) to v) add up to 100 wt. %.

It is preferred that the overall amounts of the propylene polymer (PP), the nitrogen-containing flame retardant (FR), the fibers (F), the adhesion promoter (AP) and the additives (AD) together make up at least 90 wt.-% of the polypropylene composition (C), more preferably sum up to 100 wt.-%.

According to a preferred embodiment of the present invention, the polypropylene composition (C) is free of fluoropolymers. In particular, it is preferred that the polypropylene composition (C) does not contain fluoropolymers in amounts exceeding 0.5 wt.-%, more preferably 0.1 wt.-%, still more preferably 0.01 wt.-%, like 0.001 wt.-%. It is especially preferred that no fluoropolymers have been used in the production of the polypropylene composition (C).

As used herein, the term “fluoropolymer” refers to a polymeric compound comprising fluorine atoms. Examples for fluoropolymers are poly(tetrafluoro ethylene) (PTFE), tetrafluoroethylene-hexafluoropropylene-copolymer (FEP) and polychlorotrifluoroethylene (PCTFE).

It is preferred that the polypropylene composition (C) according to the present invention has a melt flow rate MFR₂ (230° ° C., 2.16 kg) determined according to ISO 1133 in the range of 6.0 to 40.0 g/10 min, more preferably in the range of 10.0 to 35.0 g/10 min, still more preferably in the range of 15.0 to 30.0 g/10 min, like in the range of 18.0 to 25.0 g/10 min.

Regarding the mechanical properties, it is preferred that the fiber polypropylene composition (C) has a tensile modulus determined according to ISO 527-1A at 23° ° C. in the range of 3000 to 12000 MPa, more preferably in the range of 4000 to 11000 MPa, still more preferably in the range of 5000 to 10000 MPa, like in the range of 6000 to 9500 MPa.

Additionally or alternatively to the previous paragraph, it is preferred that the polypropylene composition (C) has a Charpy notched impact strength determined according to ISO 179 1 eA at −30° ° C. of at least 4.0 KJ/m2, more preferably in the range of 5.0 to 12.0 KJ/m2, still more preferably in the range of 7.0 to 10.0 KJ/m2, like in the range of 7.9 to 8.5 KJ/m2 and/or a Charpy unnotched impact strength determined according to ISO 179 1 eU at −30° C. of at least 20.0 KJ/m2, more preferably in the range of 25.0 to 50.0 KJ/m2, still more preferably in the range of 35.0 to 47.0 KJ/m2, like at in the range of 40.0 to 45.0 KJ/m2.

Further, it is preferred that the polypropylene composition (C) according to the present invention fulfills the requirements of the Standard for Safety of Flammability of Plastic Materials UL 94 V-0 at a thickness of equal or less than 1.5 mm, more preferably equal or less than 1.2 mm, still more preferably equal or less than 1.0 mm, like equal or less than 0.9 mm.

According to one preferred embodiment, the polypropylene composition (C) fulfills the requirements of the Standard for Safety of Flammability of Plastic Materials UL 94 V-0, when determined according to the method “UL 94 vertical burning test” as described herein under “Measuring Methods” using a specimen of 1.5 mm thickness and applying condition part 1 (i.e. samples are conditioned in a constant room temperature of 23±2° C. and 50±10% humidity for 48 hours).

The polypropylene composition (C) is preferably obtained by blending, preferably melt-blending the propylene polymer (PP), the flame retardant composition (FR), the glass fibers (GF), the adhesion promoter (AP) and optionally the additives (AD).

In the following, the propylene polymer (PP), the flame retardant composition (FR), the glass fibers (GF) and the adhesion promoter (AP) are described in more detail.

### The Propylene Polymer (PP)

The polypropylene composition (C) according to the present invention comprises a propylene polymer (PP). The propylene polymer (PP) can also be a mixture of two or more propylene polymer (PP) components.

The propylene polymer (PP) has a melt flow rate MFR₂ (230° C., 2.16 kg) determined according to ISO 1133 of at least 45.0 g/10 min, more preferably in the range of 45.0 to 300 g/10 min, still more preferably in the range of 60.0 to 200 g/10 min, like in the range of 80.0 to 120 g/10 min.

According to one embodiment, the propylene polymer (PP) has a melt flow rate MFR₂ (230° ° C., 2.16 kg) determined according to ISO 1133 of at least 45.0 g/10 min (e.g. in the range of 45.0 to 500 g/10 min, 45.0 to 200 g/10 min, or 45.0 to 130 g/10 min), preferably at least 50.0 g/10 min (e.g. in the range of 50.0 to 500 g/10 min, 50.0 to 200 g/10 min, or 50.0 to 130 g/10 min), preferably in the range of 50.0 to 600 g/10 min, more preferably in the range of 55.0 to 600 g/10 min (e.g. in the range of 55.0 to 500 g/10 min, 55.0 to 200 g/10 min, or 55.0 to 130 g/10 min), more preferably the range of 60.0 to 550 g/10 min (e.g. in the range of 60.0 to 500 g/10 min, 60.0 to 200 g/10 min, or 60.0 to 130 g/10 min), still more preferably in the range of 60.0 to 500 g/10 min, yet even more preferably in the range of 60.0 to 470 g/10 min, yet even more preferably in the range of 60.0 to 300 g/10 min, and yet even more preferably in the range of 60.0 to 200 g/10 min, and yet even more preferably in the range of 60.0 to 130 g/10 min, like in the range of 80.0 to 120 g/10 min.

According to one embodiment, the propylene polymer (PP) has a melt flow rate MFR₂ (230° ° C., 2.16 kg) determined according to ISO 1133 in the range of 105 to 600 g/10 min, optionally 110 to 550 g/10 min, and optionally 120 to 500 g/10 min, and optionally 200 to 500 g/10 min, and optionally 300 to 500 g/10 min.

The propylene polymer (PP) can be a homopolymer or copolymer of propylene. Moreover, the propylene polymer (PP) can comprise one or more propylene polymer (PP) components which are different.

In case the propylene polymer (PP) is a copolymer of propylene, it is preferred that the comonomer is selected from ethylene and/or C₄ to C₈ α-olefins. It is especially preferred that the comonomer is ethylene. For propylene polymers (PP) comprising more than one, like two different propylene polymer components which are copolymers of propylene, it is preferred that all propylene polymer components contain the same comonomer, like ethylene.

It is preferred that the propylene polymer (PP) is a copolymer of propylene and ethylene and/or at least another C₄ to C₈ α-olefin.

The propylene polymer (PP) preferably has a comonomer content, like ethylene content, in the range of 2.0 to 25.0 mol-%, more preferably in the range of 4.0 to 20.0 mol-%, still more preferably in the range of 6.0 to 15.0 mol-%, like in the range of 6.2 to 12.0 mol-%.

In a preferred embodiment of this invention, propylene polymer (PP) is a heterophasic propylene copolymer (HECO) comprising
i) a matrix (M) being a polymer of propylene
ii) an elastomer (E) being a copolymer comprising units derived from propylene and ethylene and/or C₄ to C₈ α-olefin.

Generally in the present invention, the expression “heterophasic” indicates that the elastomer is (finely) dispersed in the matrix. In other words the elastomer forms inclusion in the matrix. Thus the matrix contains (finely) dispersed inclusions being not part of the matrix and said inclusions contain the elastomer. The term “inclusion” according to this invention shall preferably indicate that the matrix and the inclusion form different phases within the heterophasic polypropylene, said inclusions are for instance visible by high resolution microscopy, like electron microscopy or scanning force microscopy.

It is appreciated that the propylene polymer (PP) being a heterophasic propylene copolymer (HECO) preferably has a rather low total comonomer content, preferably ethylene content. Thus, it is preferred that the comonomer content of the heterophasic propylene copolymer (HECO) is in the range from 4.0 to 17.0 mol-%, preferably in the range from 5.0 to 14.0 mol-%, more preferably in the range from 6.0 to 10.0 mol-%.

Heterophasic propylene copolymers (HECO) are generally featured by a xylene cold soluble (XCS) fraction and a xylene cold insoluble (XCI) fraction. For the purpose of the present application the xylene cold soluble (XCS) fraction of the heterophasic propylene copolymers (HECO) is essentially identical with the elastomer of said heterophasic propylene copolymers (HECO).

Accordingly when talking about the intrinsic viscosity and the ethylene content of elastomer of the heterophasic propylene copolymers (HECO) the intrinsic viscosity and the ethylene content of the xylene cold soluble (XCS) fraction of said heterophasic propylene copolymers (HECO) is meant.

Accordingly, the matrix (M) content, i.e. the xylene cold insoluble (XCI) content, in the propylene polymer (PP) being a heterophasic propylene copolymer (HECO) is preferably in the range of 75.0 to 93.0 wt %, more preferably in the range of 77.0 to 91.0 wt.-%, like 78.0 to 89.0 wt.-%.

On the other hand the elastomer (E), i.e. the xylene cold soluble (XCS) content, in the propylene polymer (PP) being a heterophasic propylene copolymer (HECO) is preferably in the range of 7.0 to 25.0 wt.-%, more preferably in the range of 9.0 to 23.0 wt.-%, like in the range of 11.0 to 22.0 wt.-%.

The first component of the propylene polymer (PP) as a heterophasic propylene copolymer (HECO) is the matrix (M).

Polypropylenes suitable for use as matrix (M) may include any type of isotactic or predominantly isotactic polypropylene homopolymer or random copolymer known in the art. Thus the polypropylene may be a propylene homopolymer or an isotactic random copolymer of propylene with ethylene and/or C4 to C8 alpha-olefins, such as for example 1-butene, 1-hexene or 1-octene, wherein the total comonomer content ranges from 0.05 to 10 wt.-%.

Further and preferably the polypropylene matrix (M) has a rather high melt flow rate. Accordingly, it is preferred that in the present invention the polypropylene matrix (M), i.e. the xylene cold insoluble (XCI) fraction of the propylene polymer (PP), has a melt flow rate MFR₂ (230° C., 2.16 kg) determined according to ISO1133 of in a range of 100 to 1500 g/10 min, more preferably of 120 to 800 g/10 min, still more preferably of 140 to 600 g/10 min, like in the range of 150 to 500 g/10 min.

Furthermore, the polypropylene matrix (M) can be multimodal or bimodal in view of the molecular weight.

The expression “multimodal” or “bimodal” used throughout the present invention refers to the modality of the polymer, i.e.
the form of its molecular weight distribution curve, which is the graph of the molecular weight fraction as a function of its molecular weight,
   and/or
the form of its comonomer content distribution curve, which is the graph of the comonomer content as a function of the molecular weight of the polymer fractions.

The second component of the propylene polymer (PP) as a heterophasic propylene copolymer (HECO) is the elastomer (E).

The elastomer (E) comprises, preferably consists of, units derivable from (i) propylene and (ii) ethylene and/or at least another C4 to C20 α-olefin, like C4 to C10 α-olefin, more preferably units derivable from (i) propylene and (ii) ethylene and at least another α-olefin selected form the group consisting of 1-butene, 1-pentene, 1-hexene, 1-heptene and 1-octene. The elastomer (E) may additionally contain units derived from a conjugated diene, like butadiene, or a non-conjugated diene, however it is preferred that the elastomeric copolymer consists of units derivable from (i) propylene and (ii) ethylene and/or C4 to C20 α-olefins only. Suitable non-conjugated dienes, if used, include straight-chain and branched-chain acyclic dienes, such as 1,4-hexadiene, 1,5-hexadiene, 1,6-octadiene, 5-methyl-1,4-hexadiene, 3,7-dimethyl-1,6-octadiene, 3,7-dimethyl-1,7-octadiene, and the mixed isomers of dihydromyrcene and dihydro-ocimene, and single ring alicyclic dienes such as 1,4-cyclohexadiene, 1,5-cyclooctadiene, 1,5-cyclododecadiene, 4-vinyl cyclohexene, 1-allyl-4-isopropylidene cyclohexane, 3-allyl cyclopentene, 4-cyclohexene and 1-isopropenyl-4-(4-butenyl) cyclohexane. Multi-ring alicyclic fused and bridged ring dienes are also suitable including tetrahydroindene, methyltetrahydroindene, dicyclopentadiene, bicyclo (2,2,1) hepta-2,5-diene, 2-methyl bicycloheptadiene, and alkenyl, alkylidene, cycloalkenyl and cycloalkylidene norbornenes, such as 5-methylene-2-norbornene, 5-isopropylidene norbornene, 5-(4-cyclopentenyl)-2-norbornene; and 5-cyclohexylidene-2-norbornene. Preferred non-conjugated dienes are 5-ethylidene-2-norbornene, 1,4-hexadiene and dicyclopentadiene.

Accordingly the elastomer (E) comprises at least units derivable from propylene and ethylene and may comprise other units derivable from a further α-olefin as defined in the previous paragraph. However it is in particular preferred that elastomer (E) comprises units only derivable from propylene and ethylene and optionally a conjugated diene, like butadiene, or a non-conjugated diene as defined in the previous paragraph, like 1,4-hexadiene. Thus an ethylene propylene non-conjugated diene monomer polymer (EPDM) and/or an ethylene propylene rubber (EPR) as elastomer (E) is especially preferred, the latter most preferred.

Like the matrix (M), the elastomer (E) can be unimodal or multimodal, like bimodal. Concerning the definition of unimodal and multimodal, like bimodal, it is referred to the definition above.

In the present invention the content of units derivable from propylene in the elastomer (E) equates with the content of propylene detectable in the xylene cold soluble (XCS) fraction. Accordingly the propylene detectable in the xylene cold soluble (XCS) fraction ranges from 45.0 to 75.0 wt.-%, more preferably 40.0 to 70.0 wt.-%. Thus in a specific embodiment the elastomer (E), i.e. the xylene cold soluble (XCS) fraction, comprises from 25.0 to 65.0 wt.-%, more preferably 30.0 to 60.0 wt.-%, units derivable from ethylene. Preferably the elastomer (E) is an ethylene propylene non-conjugated diene monomer polymer (EPDM) or an ethylene propylene rubber (EPR), the latter especially preferred, with a propylene and/or ethylene content as defined in this paragraph.

Additionally, it is preferred that the comonomer content, preferably ethylene content, of the xylene cold soluble (XCS) fraction of the propylene polymer (PP) being a heterophasic propylene copolymer (HECO) is equal or above 35.0 mol-%, preferably in the range of 35.0 to 65.0 mol-%, more preferably in the range of 45.0 to 60.0 mol.-%, yet more preferably in the range of 50.0 to 56.0 mol.-%. The comonomers present in the xylene cold soluble (XCS) fraction are those defined above for the elastomer (E). In one preferred embodiment the comonomer is ethylene only.

A further preferred requirement of the present invention is that the intrinsic viscosity (IV) of the xylene cold soluble (XCS) fraction of the propylene polymer (PP) being a heterophasic propylene copolymer (HECO) is rather low. Accordingly it is appreciated that the intrinsic viscosity of the xylene cold soluble (XCS) fraction of the propylene polymer (PP) being a heterophasic propylene copolymer (HECO) is below 3.5 dl/g, more preferably not more than 3.4 dl/g. Even more preferred, the intrinsic viscosity of the xylene cold soluble (XCS) fraction of the propylene polymer (PP) being a heterophasic propylene copolymer (HECO) is in the range of 1.8 to 3.5 dl/g, more preferably in the range 1.9 to 3.4 dl/g, like 2.0 to 3.4 dl/g. The intrinsic viscosity is measured according to ISO 1628 in decalin at 135° C.

Preferably, the propylene content of the propylene polymer (PP) is 85.0 to 96.0 wt %, more preferably 88.0 to 94.0 wt %, based on total weight of propylene polymer (PP), more preferably based the amount of the matrix (M) and the elastomeric copolymer (E) together, in case that the propylene polymer (PP) is a heterophasic propylene copolymer (HECO) as defined above.

The propylene polymer (PP) being a heterophasic propylene copolymer (HECO) can be produced by blending the matrix (M) and the elastomer (E). However, it is preferred that the heterophasic propylene copolymer (HECO) is produced in a sequential step process, using reactors in serial configuration and operating at different reaction conditions. As a consequence, each fraction prepared in a specific reactor may have its own molecular weight distribution and/or comonomer content distribution.

The propylene polymer (PP) being a heterophasic propylene copolymer (HECO) according to this invention is preferably produced in a sequential polymerization process, i.e. in a multistage process, known in the art, wherein the (semi)crystalline propylene polymer (M) is produced at least in one slurry reactor, preferably in a slurry reactor and optionally in a subsequent gas phase reactor, and subsequently the elastomer (E) is produced at least in one, i.e. one or two, gas phase reactor(s).

Accordingly it is preferred that the propylene polymer (PP) being a heterophasic propylene copolymer (HECO) is produced in a sequential polymerization process comprising the steps of
(a) polymerizing propylene and optionally at least one ethylene and/or C₄ to C₁₂ α-olefin in a first reactor (R1) obtaining the first polypropylene fraction of the matrix (M), preferably said first polypropylene fraction is a propylene homopolymer,
(b) optionally transferring the first polypropylene fraction into a second reactor (R2),
(c) optionally polymerizing in the second reactor (R2) and in the presence of said first polypropylene fraction propylene and optionally at least one ethylene and/or C₄ to C₁₂ α-olefin obtaining thereby a second polypropylene fraction, preferably said second polypropylene fraction is a second propylene homopolymer, said first polypropylene fraction and optionally said second polypropylene fraction form the matrix (M), i.e. the matrix of the heterophasic propylene copolymer (HECO),
(d) transferring the matrix (M) of step (c) into a third reactor (R3),
(e) polymerizing in the third reactor (R3) and in the presence of the matrix (M) obtained in step (a) or (c) propylene and ethylene to obtain the elastomer (E) dispersed in the matrix (M), the matrix (M) and the elastomer (E) form the propylene polymer (PP) being a heterophasic propylene copolymer (HECO).

It is preferred that the propylene polymer (PP) being a heterophasic propylene copolymer (HECO) is prepared in the presence of
(a) a Ziegler-Natta catalyst comprising compounds (TC) of a transition metal of Group 4 to 6 of IUPAC, a Group 2 metal compound (MC) and an internal donor (ID);
(b) optionally a co-catalyst (Co), and
(c) optionally an external donor (ED).

This Ziegler-Natta catalyst can be any stereospecific Ziegler-Natta catalyst for propylene polymerization, which preferably is capable of catalyzing the polymerization and copolymerization of propylene and optional comonomers at a pressure of 500 to 10000 kPa, in particular 2500 to 8000 kPa, and at a temperature of 40 to 110° C., in particular of 60 to 110° C.

Preferably, the Ziegler-Natta catalyst comprises a high-yield Ziegler-Natta type catalyst including an internal donor component, which can be used at high polymerization temperatures of 80° C. or more. Such high-yield Ziegler-Natta catalyst can comprise a succinate, a diether, a phthalate etc., or mixtures therefrom as internal donor (ID) and are for example commercially available from LyondellBasell. An example for a suitable catalyst is the catalyst ZN180M of LyondellBasell.

According to one preferred embodiment of the present invention, the propylene polymer (PP) consists of the heterophasic propylene copolymer (HECO).

In another embodiment, the propylene polymer (PP) comprises the heterophasic propylene copolymer (HECO) and one or more further homo- or copolymers of propylene such as further heterophasic propylene copolymers. In case the propylene polymer (PP) comprises further copolymers of propylene such as further heterophasic propylene copolymers, it is preferred that the heterophasic propylene copolymer (HECO) and the further copolymers of propylene contain the same comonomer, preferably ethylene.

According to one alternative embodiment, the propylene polymer (PP) is a homopolymer of propylene.

A “homopolymer of propylene” as used herein relates to a polypropylene that consists substantially, i.e. of at least 99.0 wt.-%, more preferably of at least 99.5 wt.-%, still more preferably of at least 99.8 wt.-%, like of at least 99.9 wt.-%, of propylene units. In another embodiment only propylene units are detectable, i.e. only propylene has been polymerized.

According to one embodiment, the propylene polymer (PP) is a homopolymer of propylene, wherein the propylene polymer (PP) has a melt flow rate MFR₂ (230° C., 2.16 kg) determined according to ISO 1133 of at least 50.0 g/10 min, preferably in the range of 50.0 to 600 g/10 min, more preferably in the range of 55.0 to 600 g/10 min, more preferably the range of 60.0 to 550 g/10 min, still more preferably in the range of 60.0 to 500 g/10 min, yet even more preferably of 60.0 to 470 g/10 min.

According to one embodiment, the propylene polymer (PP) is a homopolymer of propylene, wherein the propylene polymer (PP) has a melt flow rate MFR₂ (230° C., 2.16 kg) determined according to ISO 1133 in the range of 60.0 to 300 g/10 min, like in the range of 60.0 to 200 g/10 min, like in the range of 60.0 to 130 g/10 min, like in the range of 80.0 to 120 g/10 min.

According to one embodiment, the propylene polymer (PP) is a homopolymer of propylene, wherein the propylene polymer (PP) has a melt flow rate MFR₂ (230° C., 2.16 kg) determined according to ISO 1133 in the range of 105 to 600 g/10 min, optionally 110 to 550 g/10 min, and optionally 120 to 500 g/10 min, and optionally 200 to 500 g/10 min, and optionally 300 to 500 g/10 min.

According to one embodiment, the propylene polymer (PP) is a homopolymer of propylene, and wherein the propylene polymer (PP) comprises two or more, preferably two, propylene homopolymer (PP) components, which differ in their melt flow rate MFR₂ (230° C., 2.16 kg) determined according to ISO 1133.

According to one embodiment, the propylene polymer (PP) is a homopolymer of propylene, and wherein the propylene polymer (PP) comprises two or more, preferably two, propylene homopolymer (PP) components, which differ in their melt flow rate MFR₂ (230° C., 2.16 kg) determined according to ISO 1133, and wherein
a first propylene homopolymer component has a melt flow rate MFR₂ (230° C., 2.16 kg) determined according to ISO 1133 in the range of 50.0 to 125 g/10 min, preferably 60.0 to 100 g/10 min, and more preferably 70.0 to 90.0 g/10 min,
a second propylene homopolymer component has a melt flow rate MFR₂ (230° C., 2.16 kg) determined according to ISO 1133 in the range of 105 to 300 g/10 min, preferably 110 to 200 g/10 min, and more preferably 120 to 140 g/10 min.

### The Flame Retardant Composition (FR)

The polypropylene composition (C) according to the present invention comprises a nitrogen-containing flame retardant (FR).

According to a preferred embodiment of the present invention, the nitrogen-containing flame retardant (FR) is free of halogens. In other words, it is preferred that the nitrogen-containing flame retardant (FR) does not contain any organic or inorganic compounds containing halogen atoms. As used herein, the term “halogen” refers to the elements of group 17 of the periodic table.

It is preferred that the nitrogen-containing flame retardant (FR) comprises at least one nitrogen-containing phosphate, preferably at least one organic nitrogen-containing phosphate. Preferably, said organic nitrogen-containing phosphate is a phosphate of heterocyclic C₃-C₆-, more preferably C₃-C₄-alkyl or -aryl compounds comprising at least one N-atom.

According to a preferred embodiment of the present invention, the nitrogen-containing flame retardant (FR) comprises a first nitrogen-containing phosphate (FR1) and a second nitrogen-containing phosphate (FR2) different from the first nitrogen-containing phosphate (FR1).

Preferably, the first nitrogen-containing phosphate (FR1) and the second nitrogen-containing phosphate (FR2) are organic nitrogen-containing phosphates. It is especially preferred that the first nitrogen-containing phosphate (FR1) and the second nitrogen-containing phosphate (FR2) are phosphates of heterocyclic C₃-C₆-, more preferably C₃-C₄-alkyl or -aryl compounds comprising at least one N-atom.

It is preferred that the first nitrogen-containing phosphate (FR1) is an organic nitrogen-containing polyphosphate. More preferably, the first nitrogen-containing phosphate (FR1) is a polyphosphate of a heterocyclic C₃-C₆-, more preferably C₃-C₄-aryl compound comprising at least one N-atom. It is especially preferred that the first nitrogen-containing phosphate (FR1) is melamine polyphosphate.

It is preferred that the second nitrogen-containing phosphate (FR2) is an organic nitrogen-containing diphosphate. More preferably, the second nitrogen-containing phosphate (FR2) is a diphosphate of a heterocyclic C₃-C₆-, more preferably C₃-C₄-alkyl compound comprising at least one N-atom, like two N-atoms. It is especially preferred that the second nitrogen-containing phosphate (FR2) is piperazine pyrophosphate.

According to a preferred embodiment of the present invention, the weight ratio between the first nitrogen-containing phosphate (FR1) and the second nitrogen-containing phosphate (FR2) is in the range of 60:40 to 40:60.

Suitable nitrogen-containing flame retardants (FR) are preferably commercially available. A highly suitable example of a commercial nitrogen-containing flame retardant (FR) is the flame retardant product sold under the trade name Phlamoon-1090A, produced and supplied by SULI.

As outlined above, the polypropylene composition (C) according to the present invention comprises 10.0 to 40.0 wt.-%, preferably 18.0 to 35.0 wt.-%, more preferably 20.0 to 38.0 wt.-%, still more preferably 20.0 to 30.0 wt.-%, even more preferably 20.0 to 27.0 wt. %, like 20.0 to 25.0 wt.-% of the nitrogen-containing flame retardant (FR), based on the overall weight of the polypropylene composition (C).

The amount of the nitrogen-containing flame retardant (FR) means herein the amount based on the overall weight of the polypropylene composition (C) of the nitrogen-containing flame retardant (FR) as supplied by the producer thereof. Accordingly, the nitrogen-containing flame retardant (FR) may contain further components in minor amounts, like additives, flame retardant synergists and/or carrier medium. Thus it is to be understood that such further components are calculated to the amount of the nitrogen-containing flame retardant (FR).

### The Fibers (F)

Essential components of the polypropylene composition (C) according to the present invention are fibers (F).

Preferably the fibers (F) are selected from the group consisting of glass fibers, carbon fibers, polymeric fibers, cellulose fibers, metal fibers, mineral fibers, ceramic fibers and mixtures thereof. More preferably, the fibers (F) are glass fibers and/or carbon fibers.

It is especially preferred that the fibers (F) are glass fibers (GF). Preferably, the glass fibers (GF) are cut glass fibers, also known as short glass fibers (SGF) or chopped strands, and/or long glass fibers (LGF), preferably long glass fibers (LGF) obtained from glass rovings.

It is particularly preferred that the fibers (F) are short glass fibers (SGF)

The cut or short glass fibers (SGF) within the fiber reinforced composition (C) preferably have a weight average fiber length determined according to FASEP after injection moulding according to EN ISO 1873-2 of the fiber reinforced composition (C) in the range of 0.2 to 1.2 mm, more preferably in the range of 0.25 to 1.0 mm, still more preferably in the range of 0.3 to 0.8 mm.

The initial average length of the short glass fibers (SGF) as provided by the supplier, i.e. the average length of the short fibers (SFG) before melt blending with the propylene polymer (PP), the flame retardant (FR) and the optional adhesion promoter (AP), differs from the above mentioned weight average fiber length of the short glass fibers (SGF) within the fiber reinforced composition (C).

The cut or short glass fibers (SGF) used in the fiber reinforced composition (C) preferably have an initial average length in the range of from 2.0 to 10.0 mm, more preferably in the range of 2.3 to 9.0 mm, still more preferably in the range of 2.5 to 8.0 mm, like in the range of 3.0 to 7.0 mm.

The cut or short glass fibers (SGF) used in the fiber reinforced composition (C) preferably have an average diameter of from 5 to 20 μm, more preferably from 6 to 18 μm, still more preferably 8 to 16 μm.

Preferably, the short glass fibers (SGF) have an initial aspect ratio of 125 to 650, preferably of 150 to 500, more preferably 200 to 450. The aspect ratio is the relation between average length and average diameter of the fibers.

The initial average length and initial average aspect ratio of the short glass fibers (SGF) refer to the values of the raw material as provided by the supplier.

### The Adhesion Promoter (AP)

In accordance with the present invention, the polypropylene composition (C) optionally further comprises an adhesion promoter (AP). The adhesion promoter (AP) is specified as being a polar modified polypropylene (PM-PP) homo- or copolymer.

For embodiments of the present invention wherein the fibers (F) are glass fibers and/or carbon fibers, it is preferred that the polypropylene composition (C) comprises the adhesion promoter (AP).

The polar modified polypropylene (PM-PP) homo- or copolymer comprises a low molecular weight compound having reactive polar groups. Modified polypropylene homopolymers and copolymers, like copolymers of propylene and ethylene or with other α-olefins, e.g. C₄ to C₁₀ α-olefins, are most preferred, as they are highly compatible with the propylene polymer (PP) of the polypropylene composition (C).

In terms of structure, the polar modified polypropylene (PM-PP) homo- or copolymer are preferably selected from graft homo- or copolymers.

In this context, preference is given to polar modified polypropylene (PM-PP) homo- or copolymers containing groups derived from polar compounds, in particular selected from the group consisting of acid anhydrides, carboxylic acids, carboxylic acid derivatives, primary and secondary amines, hydroxyl compounds, oxazoline and epoxides, and also ionic compounds.

Specific examples of said polar compounds are unsaturated cyclic anhydrides and their aliphatic diesters, and the diacid derivatives. In particular, one can use maleic anhydride and compounds selected from C₁ to C₁₀ linear and branched dialkyl maleates, C₁ to C₁₀ linear and branched dialkyl fumarates, itaconic anhydride, C₁ to C₁₀ linear and branched itaconic acid dialkyl esters, acrylic acid, maleic acid, fumaric acid, itaconic acid and mixtures thereof.

Particular preference is given to use a polypropylene homo- or copolymer grafted with maleic anhydride or acrylic acid as the polar modified polypropylene (PM-PP) homo- or copolymer, i.e. the adhesion promoter (AP).

The modified polymer, i.e. the adhesion promoter, can be produced in a simple manner by reactive extrusion of the polymer, for example with maleic anhydride or acrylic acid in the presence of free radical generators (like organic peroxides), as disclosed for instance in U.S. Pat. Nos. 4,506,056, 4,753,997 or EP 1 805 238.

Preferred amounts of groups derived from polar compounds in the polar modified polypropylene (PM-PP) homo- or copolymer, i.e. the adhesion promoter (AP), are from 0.5 to 5.0 wt.-%. For example, the amount may be in the range of 0.5 wt.-% to 4.5 wt.-%, preferably in the range of 0.5 wt.-% to 4.0 wt.-%, more preferably in the range of 0.5 wt.-% to 3.5 wt.-%.

Preferred values of the melt flow rate MFR₂ (230° C., 2.16 kg) for the polar modified polypropylene (PM-PP) homo- or copolymer, i.e. for the adhesion promoter (AP), are from 20.0 to 400 g/10 min. It is particularly preferred that the polar modified polypropylene (PM-PP) homo- or copolymer has a melt flow rate MFR₂ (230° C., 2.16 kg) in the range of 40.0 to 300 g/10 min, more preferably in the range of 50.0 to 250 g/10 min.

In one preferred embodiment of the present invention, the adhesion promoter (AP) is a maleic anhydride modified polypropylene homo- or copolymer and/or an acrylic acid modified polypropylene homo- or copolymer. Preferably, the adhesion promoter (AP) is a maleic anhydride modified polypropylene homopolymer and/or an acrylic acid modified polypropylene homopolymer and preferably a maleic anhydride modified polypropylene homopolymer. For example, suitable polar modified polypropylene (PM-PP) homo- or copolymers include, for example, a polypropylene homopolymer grafted with maleic anhydride (PP-g-MAH) and a polypropylene homopolymer grafted with acrylic acid (PP-g-AA).

### The Additives (AD)

In addition to the propylene copolymer (PP), the nitrogen-containing flame retardant (FR), the fibers (F) and the optional adhesion promoter (AP), the polypropylene composition (C) of the invention may include additives (AD). Typical additives are acid scavengers, antioxidants, colorants, light stabilizers, slip agents, anti-scratch agents, dispersing agents, processing aids, lubricants, pigments, and the like.

The content of additives in the polypropylene composition (C) of the invention will normally not exceed 5.0 wt.-%, preferably being in the range of 0.5 to 3.5 wt.-%.

Such additives are commercially available and for example described in “Plastic Additives Handbook”, 6th edition 2009 of Hans Zweifel (pages 1141 to 1190).

Furthermore, the term “additives (AD)” according to the present invention also includes carrier materials, in particular polymeric carrier materials.

### The Polymeric Carrier Material

Preferably the polypropylene composition (C) of the invention does not comprise (a) further polymer (s) different to the propylene polymer (PP) and the adhesion promoter (AP), in an amount exceeding 5.0 wt.-%, preferably in an amount exceeding 3.0 wt.-%, more preferably in an amount exceeding 2.0 wt.-%, based on the weight of the fiber reinforced polypropylene composition (C). Any polymer being a carrier material for additives (AD) is not calculated to the amount of polymeric compounds as indicated in the present invention, but to the amount of the respective additive.

The polymeric carrier material of the additives (AD) is a carrier polymer to ensure a uniform distribution in the polypropylene composition (C) of the invention. The polymeric carrier material is not limited to a particular polymer. The polymeric carrier material may be ethylene homopolymer, ethylene copolymer obtained from ethylene and α-olefin comonomer such as C₃ to C₈ α-olefin comonomer, propylene homopolymer and/or propylene copolymer obtained from propylene and α-olefin comonomer such as ethylene and/or C₄ to C₈ α-olefin comonomer. It is preferred that the polymeric carrier material does not contain monomeric units derivable from styrene or derivatives thereof.

### The Article

The present invention also relates to an article comprising the polypropylene composition (C) as defined above. The present invention in particular relates to an article comprising at least 60 wt.-%, more preferably at least 80 wt.-%, still more preferably at least 90 wt.-%, like at least 95 wt.-% or at least 99 wt.-%, of the polypropylene composition (C) as defined above. In an especially preferred embodiment the present invention relates to an article consisting of the polypropylene composition (C) as defined above.

It is preferred that the article has a shrinkage in flow and cross flow determined as described below in methods below 2.0%, more preferably below 1.5%, still more preferably below 1.1%, like below 0.9%.

Preferably, the article is an automotive article in the field of electronic components such as an electric cable insulation, housings of electric devices, containers and parts of power electronic components of automobile parts and home electric appliance parts, and the like.

The present invention will now be described in further detail by the examples provided below.

### EXAMPLES

### A. Measuring Methods

The following definitions of terms and determination methods apply for the above general description of the invention as well as to the below examples unless otherwise defined. MFR₂ (230)° ° C. is measured according to ISO 1133 (230° C., 2.16 kg load). MFR₂ (190)° ° C. is measured according to ISO 1133 (190° C., 2.16 kg load).

### Quantification of Microstructure by NMR Spectroscopy

Quantitative nuclear-magnetic resonance (NMR) spectroscopy was used to quantify the comonomer content and comonomer sequence distribution of the polymers. Quantitative ¹³C{¹H} NMR spectra were recorded in the solution-state using a Bruker Advance III 400 NMR spectrometer operating at 400.15 and 100.62 MHz for ¹H and ¹³C respectively. All spectra were recorded using a ¹³C optimized 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimized tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6k) transients were acquired per spectra.

Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed Cheng, H. N., Macromolecules 17 (1984), 1950).

For polypropylene homopolymers all chemical shifts are internally referenced to the methyl isotactic pentad (mmmm) at 21.85 ppm.

Characteristic signals corresponding to regio defects (Resconi, L., Cavallo, L., Fait, A., Piemontesi, F., Chem. Rev. 2000, 100, 1253; Wang, W-J., Zhu, S., Macromolecules 33 (2000), 1157; Cheng, H. N., Macromolecules 17 (1984), 1950) or comonomer were observed.

The tacticity distribution was quantified through integration of the methyl region between 23.6-19.7 ppm correcting for any sites not related to the stereo sequences of interest (Busico, V., Cipullo, R., Prog. Polym. Sci. 26 (2001) 443; Busico, V., Cipullo, R., Monaco, G., Vacatello, M., Segre, A. L., Macromoleucles 30 (1997) 6251).

Specifically the influence of regio defects and comonomer on the quantification of the tacticity distribution was corrected for by subtraction of representative regio defect and comonomer integrals from the specific integral regions of the stereo sequences.

The isotacticity was determined at the pentad level and reported as the percentage of isotactic pentad (mmmm) sequences with respect to all pentad sequences:

[mmmm] %=100*(mmmm/sum of all pentads)

The presence of 2,1 erythro regio defects was indicated by the presence of the two methyl sites at 17.7 and 17.2 ppm and confirmed by other characteristic sites.

Characteristic signals corresponding to other types of regio defects were not observed (Resconi, L., Cavallo, L., Fait, A., Piemontesi, F., Chem. Rev. 2000, 100, 1253).

The amount of 2,1 erythro regio defects was quantified using the average integral of the two characteristic methyl sites at 17.7 and 17.2 ppm:

P₂₁ₑ=(Iₑ₆+Iₑ₈)/2

The amount of 1,2 primary inserted propene was quantified based on the methyl region with correction undertaken for sites included in this region not related to primary insertion and for primary insertion sites excluded from this region:

P₁₂=I_{CH3}+P₁₂ₑ

The total amount of propene was quantified as the sum of primary inserted propene and all other present regio defects:

Pₜₒₜₐₗ=P₁₂+P₂₁ₑ

The mole percent of 2,1 erythro regio defects was quantified with respect to all propene:

[21e] mol %=100*(P₂₁ₑ/Pₜₒₜₐₗ)

For copolymers characteristic signals corresponding to the incorporation of ethylene were observed (Cheng, H. N., Macromolecules 17 (1984), 1950).

With regio defects also observed (Resconi, L., Cavallo, L., Fait, A., Piemontesi, F., Chem. Rev. 2000, 100, 1253; Wang, W-J., Zhu, S., Macromolecules 33 (2000), 1157; Cheng, H. N., Macromolecules 17 (1984), 1950) correction for the influence of such defects on the comonomer content was required.

The comonomer fraction was quantified using the method of Wang et. al. (Wang, W-J., Zhu, S., Macromolecules 33 (2000), 1157) through integration of multiple signals across the whole spectral region in the ¹³C{¹H} spectra. This method was chosen for its robust nature and ability to account for the presence of regio-defects when needed. Integral regions were slightly adjusted to increase applicability across the whole range of encountered comonomer contents.

For systems where only isolated ethylene in PPEPP sequences was observed the method of Wang et. al. was modified to reduce the influence of non-zero integrals of sites that are known to not be present. This approach reduced the overestimation of ethylene content for such systems and was achieved by reduction of the number of sites used to determine the absolute ethylene content to:

E=0.5(Sββ+Sβγ+Sβδ+0.5(Sαβ+Sαγ))

Through the use of this set of sites the corresponding integral equation becomes:

E=0.5(I_{H}+I_{G}+0.5(I_{C}+I_{D}))

using the same notation used in the article of Wang et. al. (Wang, W-J., Zhu, S., Macromolecules 33 (2000), 1157). Equations used for absolute propylene content were not modified.

The mole percent comonomer incorporation was calculated from the mole fraction:

E [mol %]=100*fE

The weight percent comonomer incorporation was calculated from the mole fraction:

E [wt %]=100*(fE*28.06)/((fE*28.06)+((1−fE)*42.08))

The comonomer sequence distribution at the triad level was determined using the analysis method of Kakugo et al. (Kakugo, M., Naito, Y., Mizunuma, K., Miyatake, T. Macromolecules 15 (1982) 1150). This method was chosen for its robust nature and integration regions slightly adjusted to increase applicability to a wider range of comonomer contents.

Density: ISO 1183, measured on compression moulded plaques.

Intrinsic viscosity (IV) of propylene homopolymers and copolymers is measured according to DIN ISO 1628/1, October 1999 (in Decalin at 135° C.).

The xylene cold solubles (XCS, wt.-%): Content of xylene cold solubles (XCS) was determined at 25° ° C. according ISO 16152; first edition; 2005-07-01.

Flexural Modulus: The flexural modulus was determined in 3-point-bending according to ISO 178 on injection moulded specimens of 80×10×4 mm prepared in accordance with ISO 294-1:1996.

Charpy notched impact strength was determined according to ISO 179-1/1 eA at 23° C. and −30° ° C. by using injection moulded test specimens (80×10×4 mm) prepared according to EN ISO 1873-2.

Charpy unnotched impact strength was determined according to ISO 179-1/1 eU at 23° C. and −30° C. by using injection moulded test specimens (80×10×4 mm) prepared according to EN ISO 1873-2.

Tensile properties were determined on injection moulded dogbone specimens of 4 mm thickness prepared in accordance with EN ISO 1873-2. Tensile modulus was determined according to ISO 527-1A at a strain rate of 1 mm/min and 23° C., 80° C. and 120° C., stress at yield was determined at a strain rate of 50 mm/min and 23° C., 80° C. and 120° C.

Ash content is measured according to ISO 3451-1 (1997) standard.

Average fiber diameter is determined according to ISO 1888:2006(E), Method B.

Weight average fiber length and fiber length distribution were determined according to the FASEP (FAser (German; fiber) SEParation) method on injection moulded test specimens prepared in accordance with EN ISO 1873-2. The fibers are separated from the polymer matrix by pyrolysis in a TGA oven (625° C. for glass fibers, 500° C. for carbon fibers) or by solution and physical separation. The separated fibers are suspended in de-ionized water and the suspension is diluted until the number of fibers and the overlaying of fibers is well balanced. The average fiber length is determined by grey scale image processing on a FASEP 1.9.44.0 (IDM Systems, Darmstadt, Germany) and statistically investigated by calculating average fiber length and fiber length distributions. Accurate results will be achieved for images with a small number of fiber clusters and fibers that were cut in any way. This is achieved by realizing a certain fiber to water fraction. For glass fibers the fraction should be equal of below 30 mg/L, for carbon fibers the fraction should be equal or below 20 mg/L. The number of clusters relative to the free fibers should be below 20% for short fibers and below 15% for long fibers.

For evaluation FASEP software (ImageProPlus including FASEP module) is used separating fibers from background, removing dust and other not relevant features, separating fibers if overlaying and measuring automatically the length for each fiber.

The average fiber length Ln and weight average fiber length Lp is determined according to ISO 22314:05:2006:

$$Lp = \frac{\overline{{L}^{2}}}{\overline{L}}$$

$$L n = \frac{1}{n} {\sum }_{i = 1}^{n} {L}_{i} und \overline{{L}^{2}} = \frac{1}{n} {\sum }_{i = 1}^{n} {L}_{i}^{2}$$

The investigation report has to contain the following values next to the settings used:
Sum of fibres of all images combined per sample
Ln, Lp (as defined above)
Lmin, Lmax of fibres of all images combined per sample
Fibre length distribution
Fibre mass
Local fibre fraction

Heat Deflection Temperature (HDT): The HDT was determined on injection moulded test specimens of 80×10×4 mm³ prepared according to ISO 1873-2. The test was performed on flatwise supported specimens according to ISO 75, condition A, with a nominal surface stress of 1.80 MPa.

Coefficient of linear thermal expansion (CLTE): The coefficient of linear thermal expansion (CLTE) was determined in accordance with ISO 11359-2:1999 on 10 mm long pieces cut from the same injection moulded specimens as used for the flexural modulus determination. The measurement was performed in machine direction (MD) in a temperature range from 23 to 80° C. and from −30 to +80° C. at a heating rate of 1° C./min, respectively.

Shrinkage in flow and shrinkage cross flow were determined on film gate injection moulded articles. One is a circular sector (radius 300 mm and opening angle of 20°) and the other one a stripe (340×65 mm). 2.8 mm thick specimen were injection moulded at the same time at a back pressure of 400 bar. The melt temperature is 240° C. and the temperature of the tool 25° C., respectively. Average flow front velocity is 3.5±0.2 mm/s. After the injection moulding process the shrinkage of the specimens is measured at 23° C. and 50% humidity. The measurement was done 96 hours after the injection moulding.

UL94 Vertical burning test was performed according to UL 94: 2016. The samples are injection moulded in pieces 125±5 mm length, 13.0±0.5 mm width and a thickness of 0.8 to 3.2 mm. Under condition part 1, the samples must be conditioned in a constant room temperature of 23±2° C. and 50±10% humidity for 48 hours. Under condition part 2, the samples must be conditioned in an air circulating oven for 168 hours at 70±1° C. and then cooled in the desiccator for at least 4 hours at room temperature, prior to testing. Testing must take place within 30 minutes of the samples being taken from the conditioning. The sample is hanged vertically in the test chamber and subjected to a first ignition for 10 sec, then a second ignition for another 10 sec. The burning time after each ignition is recorded and it is also noted if there is afterglow, burning dripping that ignites the cotton in the bottom of the chamber and if there is flames or glow up to holding clamp. Classifications are V-0, V-1, V-2 or no classification, and the classification is dependent on the thickness of the test object.

Limited oxygen index (LOI) (Stanton Redcroft from Rheometric Scientific) was performed by following ASTM D 2863-87 and ISO 4589. The plaques prepared as described above were placed in a climate room with relative humidity 50±5% and temperature 23° C. for at least 24 hours prior to the test. Ten sample rods having length 135 mm, width 6.5 mm and thickness of 3 mm were punched from a plaque. A single sample rod was placed vertically in a glass chimney with a controlled atmosphere of oxygen and nitrogen that had been flowing through the chimney for at least 30 seconds and then ignited by an external flame on the top. If the sample had a flame present after three minutes or if the flame had burned down more than 50 mm, the test failed. Different oxygen concentrations were tested until a minimum oxygen level was reached were the sample passed the test and the flame was extinguished before three minutes or 50 mm.

### Spiral Flow Length

This method specifies a principle to test, by use of injection moulding, the flowability of a plastic material taking into consideration the cooling effect of the mould. Plastic is melted down and plasticized by a screw in a warm cylinder. Melted plastic is injected by the screw function as a piston, into a cavity with a certain speed and pressure. The cavity is shaped as a spiral with a divided scale for length measurement printed in the steel. That gives the possibility to read the flow length directly on the injection moulded test spiral specimen. Spiral Test was carried out using an Engel ES 1050/250 HL injection moulding apparatus with a spiral mould and pressure of 600, 1000 or 1400 bar
screw diameter: 55 mm
spec. injection pressure: 600, 1000, or 1400 bar
tool form: round, spiral form; length 1545 mm; profile: trapeze 2.1 mm thickness; cross sectional area 20.16 mm²
temperature in pre-chamber and die: 230° C.
temperature in zone 2/zone 3/zone 4/zone 5/zone 6: 230° C./230° C./220° C./220° C./200° ° C.
injection cycle: injection time including holding: 6 s
cooling time: 10 s
screw speed: 50 mm/sec
tool temperature: 40° C.

The spiral flow length can be determined immediately after the injection operation.

### 2. Examples

### The Propylene Polymer (PP)

### Catalyst Preparation

The catalyst for the preparation of PP1 was prepared as follows:

3.4 litre of 2-ethylhexanol and 810 mL of propylene glycol butyl monoether (in a molar ratio 4/1) were added to a 20 L reactor. Then 7.8 litre of a 20% solution in toluene of BEM (butyl ethyl magnesium) provided by Crompton GmbH were slowly added to the well stirred alcohol mixture. During the addition the temperature was kept at 10° C. After addition the temperature of the reaction mixture was raised to 60° C. and mixing was continued at this temperature for 30 minutes. Finally after cooling to room temperature the obtained Mg-alkoxide was transferred to storage vessel. 21.2 g of Mg alkoxide prepared above was mixed with 4.0 mL bis(2-ethylhexyl) citraconate for 5 min. After mixing the obtained Mg complex was used immediately in the preparation of catalyst component. 19.5 mL titanium tetrachloride was placed in a 300 mL reactor equipped with a mechanical stirrer at 25° C. Mixing speed was adjusted to 170 rpm. 26.0 of Mg-complex prepared above was added within 30 minutes keeping the temperature at 25° C. 3.0 mL of Viscoplex 1-254 and 1.0 mL of a toluene solution with 2 mg Necadd 447 was added. Then 24.0 ml of heptane was added to form an emulsion. Mixing was continued for 30 minutes at 25° C. Then the reactor temperature was raised to 90° C. within 30 minutes. The reaction mixture was stirred for further 30 minutes at 90° C. Afterwards stirring was stopped and the reaction mixture was allowed to settle for 15 minutes at 90° C.

The solid material was washed 5 times: Washings were made at 80° C. under stirring 30 min with 170 rpm. After stirring was stopped the reaction mixture was allowed to settle for 20-30 minutes and followed by siphoning.
Wash 1: Washing was made with a mixture of 100 ml of toluene and 1 mL donor
Wash 2: Washing was made with a mixture of 30 ml of TiCl₄ and 1 mL of donor.
Wash 3: Washing was made with 100 mL toluene.
Wash 4: Washing was made with 60 mL of heptane.
Wash 5. Washing was made with 60 mL of heptane under 10 minutes stirring.

Afterwards stirring was stopped and the reaction mixture was allowed to settle for 10 minutes decreasing the temperature to 70° C. with subsequent siphoning, and followed by N2 sparging for 20 minutes to yield an air sensitive powder.

### VCH Modification of the Catalyst

35 mL of mineral oil (Paraffinum Liquidum PL68) was added to a 125 mL stainless steel reactor followed by 0.82 g of triethyl aluminium (TEAL) and 0.33 g of dicyclopentyl dimethoxy silane (donor D) under inert conditions at room temperature. After 10 minutes 5.0 g of the catalyst prepared in 1a (Ti content 1.4 wt %) was added and after additionally 20 minutes 5.0 g of vinylcyclohexane (VCH) was added). The temperature was increased to 60° C. during 30 minutes and was kept there for 20 hours. Finally, the temperature was decreased to 20° C. and the concentration of unreacted VCH in the oil/catalyst mixture was analyzed and was found to be 120 ppm weight.

The catalyst used for the preparation of PP2 is the commercial Ziegler-Natta catalyst Avant ZN180M of LyondellBasell with dicyclopentyl dimethoxy silane (donor D) as external donor.

### Preparation of the Propylene Polymer PP

The conditions for the preparation of PP1 and PP2 are summarized in Table 1.

TABLE 1
Preparation and properties of PP1 and PP2

| | | PP1 | PP2 |
|---|---|---|---|
| Prepolymerization | | | |
| Co/Donor | [mol/mol] | 20 | 10 |
| Co/Ti | [mol/mol] | 250 | 220 |
| Temperature | [° C.] | 21 | 30 |
| Residence time | [min] | 20 | 5 |
| Loop (R1) | | | |
| Temperature | [° C.] | 80 | 75 |
| Split | [wt.-%] | 51 | 52 |
| H2/C3 | [mol/kmol] | 6.40 | 22.00 |
| MFR | [g/10 min] | 42 | 160 |
| GPR1 (R2) | | | |
| Temperature | [° C.] | 80 | 80 |
| Split | [wt.-%] | 30 | 34 |
| H2/C3 | [mol/kmol] | 69.3 | 175.0 |
| MFR | [g/10 min] | 42 | 160 |
| XCS | [wt.-%] | 2.0 | 2.0 |
| GPR2 (R3) | | | |
| Temperature | [° C.] | 80 | 80 |
| C2/C3 | [mol/kmol] | 399 | 550 |
| H2/C2 | [mol/kmol] | 84 | 250 |
| Split | [wt.-%] | 19 | 14 |
| MFR | [g/10 min] | 19.0 | 99.0 |
| Final | | | |
| XCS | [wt.-%] | 17.5 | 15.0 |
| C2(total) | [mol-%] | 7.5 | 8.0 |
| C2(XCS) | [mol-%] | 43.6 | 39.0 |
| IV(XCS) | [dL/g] | 2.6 | 2.0 |
| MFR | [g/10 min] | 20 | 100 |
| Tm | [° C.] | 166 | 165 |
| Tc | [° C.] | 130 | 121 |
| density | [kg/m³] | 905 | 908 |

### Preparation of the Polypropylene Composition (C)

The propylene polymers PP1 and PP2 were melt blended on a co-rotating twin screw extruder with the flame retardant composition (FR), the glass fibers (GF), the adhesion promoter (AP) and the additives (AD) in the amounts indicated in Table 2 below.

TABLE 2
Composition and properties of the
comparative and inventive examples

| | | CE1 | CE2 | IE1 | IE2 | IE3* | IE4 |
|---|---|---|---|---|---|---|---|
| PP1 | [wt.-%] | 52.35 | 42.35 | | | | |
| PP2 | [wt.-%] | | | 47.35 | 42.35 | | |
| PP3 | | | | | | 19.06 | |
| PP4 | | | | | | 23.29 | |
| PP5 | | | | | | | 42.35 |
| FR | [wt.-%] | 25.0 | 25.0 | 20.0 | 25.0 | 25.0 | 25.0 |
| GF | [wt.-%] | 20.0 | 30.0 | 30.0 | 30.0 | 30.0 | 30.0 |
| AP | [wt.-%] | 1.5 | 1.5 | 1.5 | 1.5 | 1.5 | 1.5 |
| CB | [wt.-%] | 0.7 | 0.7 | 0.7 | 0.7 | 0.7 | 0.7 |
| AO1 | [wt.-%] | 0.25 | 0.25 | 0.25 | 0.25 | 0.25 | 0.25 |
| AO2 | [wt.-%] | 0.1 | 0.1 | 0.1 | 0.1 | 0.1 | 0.1 |
| AO3 | [wt.-%] | 0.1 | 0.1 | 0.1 | 0.1 | 0.1 | 0.1 |
| Den- | [kg/m³] | 1235 | 1374 | 1272 | 1265 | 1265 | 1261 |
| sity | | | | | | | |
| MFR | [g/10 | 5.5 | 2.9 | 20.9 | 7.8 | 9.5 | 35 |
| | min] | | | | | | |

*combined PP components of PP3 and PP4 (weight ratio of 45:55) had a melt flow rate (ISO 1133; 230° C., 2.16 kg load) of about 100 g/10 min.

PP3 is the commercial propylene homopolymer HJ120UB by Borealis, which has a melt flow rate (ISO 1133; 230° C., 2.16 kg load) of 75 g/10 min.
PP4 is the commercial propylene homopolymer HK060AE by Borealis, which has a melt flow rate (ISO 1133; 230° C., 2.16 kg load) of 125 g/10 min.
PP5 is the commercial propylene homopolymer HL504FB of Borealis, which has a melt flow rate (ISO 1133; 230° C., 2.16 kg load) of 450 g/10 min.
FR is the commercial flame retardant composition Phlamoon-1090A of SULI comprising 55 to 60 wt.-% melamine polyphosphate and 40 to 55 wt.-% piperazine pyrophosphate.
GF is the commercial product ECS 03 T-480H of Nippon Electric Glass Co., Ltd. having a filament diameter of 10.5 μm and a strand length of 3 mm.
AP is the adhesion promoter SCONA TPPP 8112 GA by Scona being a polypropylene functionalized with maleic anhydride having a maleic anhydride content of 1.4 wt.-% and a MFR (190° C., 2.16 kg) above 80 g/10 min.
CB is a masterbatch comprising 40 wt.-% carbon black
AO1 is the antioxidant 2,2′-oxamido bis-(ethyl-3-(3,5-di-tert. butyl-4-hydroxyphenyl)propionate) commercially available as Naugard XL-1 of Addivant
AO2 is the antioxidant tris (2,4-di-t-butylphenyl) phosphite commercially available as Irgafos 168 of BASF
AO3 is the antioxidant pentaerythrityl-tetrakis(3-(3′,5′-di-tert. butyl-4-hydroxyphenyl)-propionate commercially available as Irganox 1010 of BASF

The flame retardancy, shrinkage and mechanical properties of the comparative and inventive compositions are summarized in Table 3.

TABLE 3
Properties of the comparative and inventive examples

| | | | | | |
|---|---|---|---|---|---|
| CE1 | CE2 | IE1 | IE2 | IE3 | IE4 |

Flame retardancy

| | | | | | | | |
|---|---|---|---|---|---|---|---|
| Class at 1.5 mm | | V-0 | V-0 | V-0 | V-0 | V-0 | V-0 |
| specimen thickness | | | | | | | |
| (condition part 1)** | | | | | | | |
| UL94 avarage t1 + t2 | | 10 | 10 | 10 | 13 | 7 | 8 |
| (condition part 1)** | | | | | | | |
| Dripping** | | no | no | no | no | no | no |
| Limited oxygen index | [%] | 41.5 | 37.5 | 35.0 | — | — | — |
| (LOI) | | | | | | | |
| Spiral flow test (600 bar) | [mm] | 380 | 326 | 500 | — | — | — |

Shrinkage

| | | | | | | | |
|---|---|---|---|---|---|---|---|
| Sector radial anisotropic | [%] | 0.31 | nd | 0.29 | — | — | — |
| Sector radial average | [%] | 0.71 | 0.58 | 0.69 | — | — | — |
| cross flow | | | | | | | |
| Sector radial average in | [%] | 0.21 | 0.16 | 0.17 | — | — | — |
| flow | | | | | | | |
| Sector radial isotropic | [%] | 0.54 | nd | 0.48 | — | — | — |
| Stripe radial anisotropic | [%] | 0.35 | 0.31 | 0.38 | — | — | — |
| Stripe radial average | [%] | 0.88 | 0.80 | 0.92 | — | — | — |
| cross flow | | | | | | | |
| Stripe radial average in | [%] | 0.14 | 0.15 | 0.14 | — | — | — |
| flow | | | | | | | |
| Stripe radial isotropic | [%] | 0.22 | 0.35 | 0.55 | — | — | — |

Mechanical properties

| | | | | | | | |
|---|---|---|---|---|---|---|---|
| Flexural modulus | [MPa] | 5969 | 8863 | 7399 | — | — | — |
| Flexural strength | [MPa] | 89 | 103 | 115 | — | — | — |
| HDT A | [° C.] | 139 | 142 | 148 | — | — | — |
| Tensile Modulus | [MPa] | 6453 | 9050 | 8186 | 9010 | 9170 | 8916 |
| (23° C., >96 hr) | | | | | | | |
| Stress at yield | [MPa] | 60 | 70 | 82 | 91 | 96 | 96 |
| (23° C., >96 hr) | | | | | | | |
| Tensile Modulus | [MPa] | 3558 | 4805 | 4779 | — | — | — |
| (80° C., >96 hr) | | | | | | | |
| Stress at yield | [MPa] | 31 | 35 | 44 | — | — | — |
| (80° C., >96 hr) | | | | | | | |
| Tensile Modulus | [MPa] | 1996 | 2635 | 3166 | — | — | — |
| (120° C., >96 hr) | | | | | | | |
| Stress at yield | [MPa] | 17 | 18 | 26 | — | — | — |
| (120° C., >96 hr) | | | | | | | |
| Charpy notched impact | [kJ/m²] | 7.9 | 8.8 | 8.1 | — | — | — |
| strength (−30° C.) | | | | | | | |
| Charpy unnotched | [kJ/m²] | 37 | 38 | 42 | — | 43 | 38 |
| impact strength (−30° C.) | | | | | | | |
| Charpy notched impact | [kJ/m²] | 11.8 | 11.5 | 9.2 | 9.8 | 10 | 9 |
| strength (23° C.) | | | | | | | |
| Charpy unnotched | [kJ/m²] | 37 | 36 | 41 | 42 | 41 | 39 |
| impact strength (23° C.) | | | | | | | |
| CLTE +23/80° C. | [μm/m/° C.] | 105.1 | 16.7 | 22.6 | — | — | — |
| CLTE −30/80° C. | [μm/m/° C.] | 89.7 | 19.2 | 24.2 | — | — | — |

**UL94 vertical burning test was carried out under condition part 1 as described above under “Measuring methods - UL94 vertical burning test”, i.e. samples were conditioned in a constant room temperature of 23 ± 2° C. and 50 ± 10% humidity for 48 hours.

As can be gathered from Table 3, the inventive composition fulfils the requirements of UL 94 V-0 at a thickness of 1.5 mm. The shrinkage values also remain on a low level even though a high flow polypropylene is applied as base polymer.

1. A polypropylene composition (C), comprising
i) 20.0 to 80.0 wt. % of a propylene polymer (PP) having a melt flow rate MFR₂ (230° C., 2.16 kg) determined according to ISO 1133 of at least 45.0 g/10 min,
ii) 10.0 to 40.0 wt. % of a nitrogen-containing flame retardant (FR),
iii) 10.0 to 40.0 wt. % of fibers (F), and
iv) 0.0 to 5.0 wt. % of an adhesion promoter (AP),
based on the overall weight of the polypropylene composition (C).

2. The polypropylene composition (C) according to claim 1, wherein the propylene polymer (PP) has a melt flow rate MFR₂ (230° C., 2.16 kg) determined according to ISO 1133 in a range of 50.0 to 600 g/10 min.

3. The polypropylene composition (C) according to claim 2, wherein the propylene polymer (PP) has a melt flow rate MFR₂ (230° C., 2.16 kg) determined according to ISO 1133 in a range of 60.0 to 300 g/10 min.

4. The polypropylene composition (C) according to claim 1, having a melt flow rate MFR₂ (230° C., 2.16 kg) determined according to ISO 1133 in a range of 6.0 to 40.0 g/10 min.

5. The polypropylene composition (C) according to claim 1, wherein:
i) the polypropylene composition (C) is free of fluoropolymers, and/or
ii) the nitrogen-containing flame retardant (FR) is free of halogens.

6. The polypropylene composition (C) according to claim 1, wherein the nitrogen-containing flame retardant (FR) comprises a first nitrogen-containing phosphate (FR1) and a second nitrogen-containing phosphate (FR2), and optionally wherein a weight ratio between the first nitrogen-containing phosphate (FR1) and the second nitrogen-containing phosphate (FR2) is in a range of 60:40 to 40:60.

7. The polypropylene composition (C) according to claim 6, wherein the first nitrogen-containing phosphate (FR1) is melamine polyphosphate and the second nitrogen-containing phosphate (FR2) is piperazine pyrophosphate.

8. The polypropylene composition (C) according to claim 1, wherein the propylene polymer (PP) is a copolymer of propylene and ethylene and/or a C₄ to C₈ α-olefin having a comonomer content in a range of 2.0 to 25.0 mol-%.

9. The polypropylene composition (C) according to claim 1, wherein the propylene polymer (PP) is a heterophasic propylene copolymer (HECO) comprising
i) a matrix (M) being a polymer of propylene, and
ii) an elastomer (E) being a copolymer comprising units derived from propylene and ethylene and/or C₄ to C₂₀ α-olefin.

10. The polypropylene composition (C) according to claim 9, wherein the heterophasic propylene copolymer (HECO) has a xylene cold soluble fraction (XCS) in a range of 7.0 to 25.0 wt. %, based on the overall weight of the heterophasic propylene copolymer (HECO).

11. The polypropylene composition (C) according to claim 9, wherein the xylene soluble fraction (XCS) of the heterophasic propylene copolymer (HECO) has:
i) a comonomer content above 35.0 mol. %, and/or
ii) an intrinsic viscosity (IV) measured according to ISO 1628/1 (at 135° ° C. in decalin) below 3.5 dl/g.

12. The polypropylene composition (C) according to claim 1, wherein the propylene polymer (PP) is a homopolymer of propylene.

13. The polypropylene composition (C) according to claim 1, wherein the propylene polymer (PP) has a melt flow rate MFR₂ (230° C., 2.16 kg) determined according to ISO 1133 in a range of 105 to 600 g/10 min.

14. The polypropylene composition (C) according to claim 1, wherein the fibers (F) are glass fibers (GF).

15. The polypropylene composition (C) according to claim 1, wherein the adhesion promoter (AP) is a polar modified polypropylene (PM-PP) being a propylene homo- or copolymer grafted with maleic anhydride having a melt flow rate MFR₂ (230° C., 2.16 kg) determined according to ISO 1133 of at least 20.0 g/10 min.

16. The polypropylene composition (C) according to claim 1, wherein the overall amounts of the propylene polymer (PP), the nitrogen-containing flame retardant (FR), the fibers (F) and optionally the adhesion promoter (AP) together make up at least 90 wt. % of the polypropylene composition (C).

17. An article, comprising the polypropylene composition (C) according to claim 1.

18. The article according to claim 17, having a shrinkage in flow and cross flow, determined as described in the description in section “Measuring methods”, of below 2.0%.

19. The polypropylene composition (C) according to claim 14, wherein the glass fibers (GF) are short glass fibers (SGF) having a weight average fiber length in a range of 0.2 to 1.2 mm, as determined according to the FASEP method as described in the description in section “Measuring methods” after injection moulding according to EN ISO 1873-2.
